(19) United States
(12) Patent Application Publication
(10) Pub. No.: US 2018/0072448 A1
(43) Pub. Date: Mar. 15, 2018

(54) DEVELOPMENT VIEW INFORMATION GENERATION DEVICE AND WRAPPING SHEET OUTPUT APPARATUS

(71) Applicant: FUJI XEROX CO., LTD., Tokyo (JP)

(72) Inventors: Daigo HAMA, Yokohama-shi (JP); Yuichi NISHIKUNI, Yokohama-shi (JP); Mizuki SUGINO, Ebina-shi (JP); Daisuke TANAKA, Ebina-shi (JP); Satoshi NAKAMURA, Ebina-shi (JP)

(73) Assignee: FUJI XEROX CO., LTD., Tokyo (JP)

(21) Appl. No.: 15/590,273

(22) Filed: May 9, 2017

(30) Foreign Application Priority Data
Sep. 9, 2016 (JP) 2016-176398
Sep. 9, 2016 (JP) 2016-176399

(51) Int. Cl. B65B 67/08; B65B 11/00; G01B 11/28; G01B 11/06; G06Q 10/04; G06T 17/05

(52) U.S. Cl. CPC B65B 67/08; B65B 11/004; G06T 17/05; G01B 11/0608; G06Q 10/043; G01B 11/285

(57) ABSTRACT

A development view information generation device includes: a reading unit that generates a flat surface image by reading a flat surface; a first recognizing unit that recognizes first dimensions that are dimensions of one of flat surfaces of a three-dimensional object using the flat surface image generated by the reading unit; a second recognizing unit that recognizes a second dimension in a direction that crosses the one flat surface of the three-dimensional object; and a generation unit that generates development view information of the three-dimensional object using the first dimensions and the second dimension.

### CROSS-REFERENCE TO RELATED APPLICATIONS

This application is based on and claims priority under 35 USC 119 from Japanese Patent Application No. 2016-176398 filed on Sep. 9, 2016 and Japanese Patent Application No. 2016-176399 filed on Sep. 9, 2016.

### BACKGROUND

### 1. Technical Field

The present invention relates to a development view information generation device and a wrapping sheet output apparatus.

### 2. Related Art

Devices for drawing such figures as a cuboid, a triangular prism, and a square cone are known.

On the other hand, techniques for automatically selecting a sheet that is suitable for the size of an input document page in printing the input document page using an image forming apparatus are known.

### SUMMARY

According to an aspect of the invention, there is provided a development view information generation device comprising a reading unit that generates a flat surface image by reading a flat surface; a first recognizing unit that recognizes first dimensions that are dimensions of one of flat surfaces of a three-dimensional object using the flat surface image generated by the reading unit; a second recognizing unit that recognizes a second dimension in a direction that crosses the one flat surface of the three-dimensional object; and a generation unit that generates development view information of the three-dimensional object using the first dimensions and the second dimension.

### BRIEF DESCRIPTION OF THE DRAWINGS

Exemplary embodiments of the present invention will be described in detail based on the following figures, wherein:

FIG. 1 is a diagram showing a general configuration of an image forming apparatus according to a first exemplary embodiment;

FIG. 2 is a diagram showing a general configuration of an image reading unit;

FIG. 3 is a side view of the image reading unit as viewed from direction III in FIG. 2;

FIG. 4 shows a state that a three-dimensional object is placed on a platen glass of a scanner unit of the image reading unit;

FIG. 5 is a block diagram showing the functional configuration of a controller;

FIG. 6 shows a development view of an object to be covered;

FIG. 7 shows an example covering method selection picture that is displayed on a UI;

FIG. 8 shows an example full wrapping method selection picture to be displayed on the UI;

FIG. 9A shows a case that the development view of the object to be covered is within a sheet size, and FIG. 9B a case that the development view of the object to be covered is not within a sheet size;

FIG. 10A shows a relationship between a development view for caramel wrapping and a sheet size, and FIG. 10B shows a relationship between a development view for Japanese diagonal wrapping and a sheet size;

FIGS. 11A and 11B show example images formed on sheets;

FIG. 12 shows an example preview picture to be displayed on the UI;

FIG. 13 is a side view, as viewed from the direction corresponding to direction III in FIG. 2, of an image reading unit employed in a second exemplary embodiment; and

FIG. 14 is a side view, as viewed from the direction corresponding to direction III in FIG. 2, of an image reading unit employed in a third exemplary embodiment.

### DESCRIPTION OF SYMBOLS

1 . . . Image forming apparatus; 10 . . . Image reading unit; 20 . . . Image forming unit; 30 . . . Controller; 31 . . . Surface recognizing unit; 32 . . . Side recognizing unit; 33 . . . Development view generation unit; 34 . . . Covering method determining unit; 35 . . . Image determining unit; 40 . . . User interface (UI); 50 . . . Sheet supply unit; 110 . . . Scanner unit; 115 . . . Distance detection sensor; 120 . . . Document feeding unit; 131 . . . Tilt sensor; 132 . . . Rotary member; 140 . . . Measuring member.

### DETAILED DESCRIPTION

Exemplary embodiments of the present invention will be hereinafter described with reference to the accompanying drawings.

### Exemplary Embodiment 1

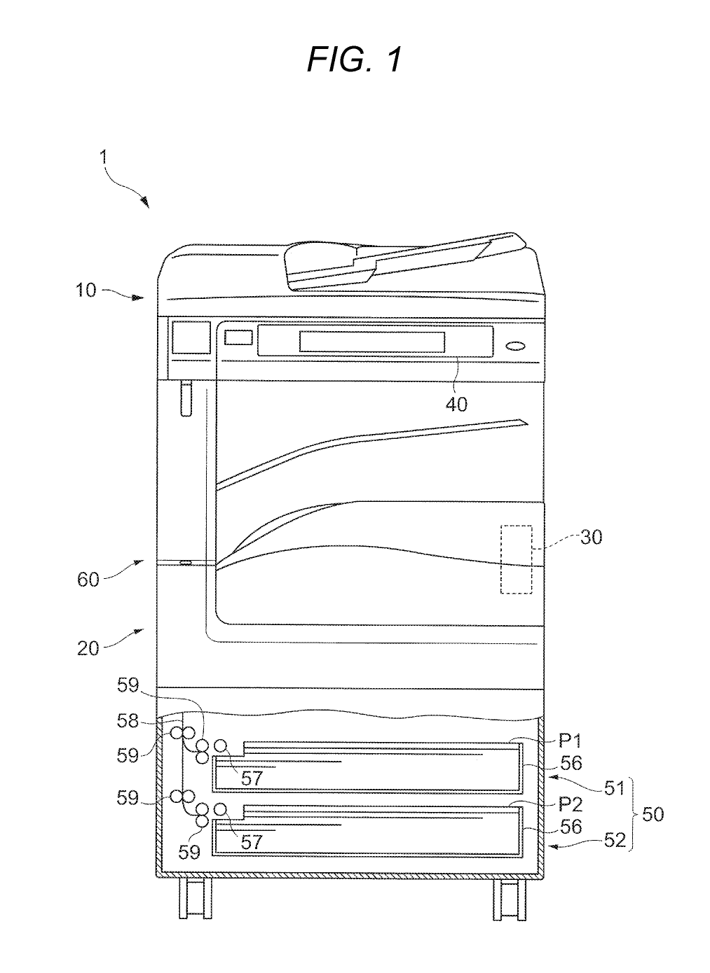

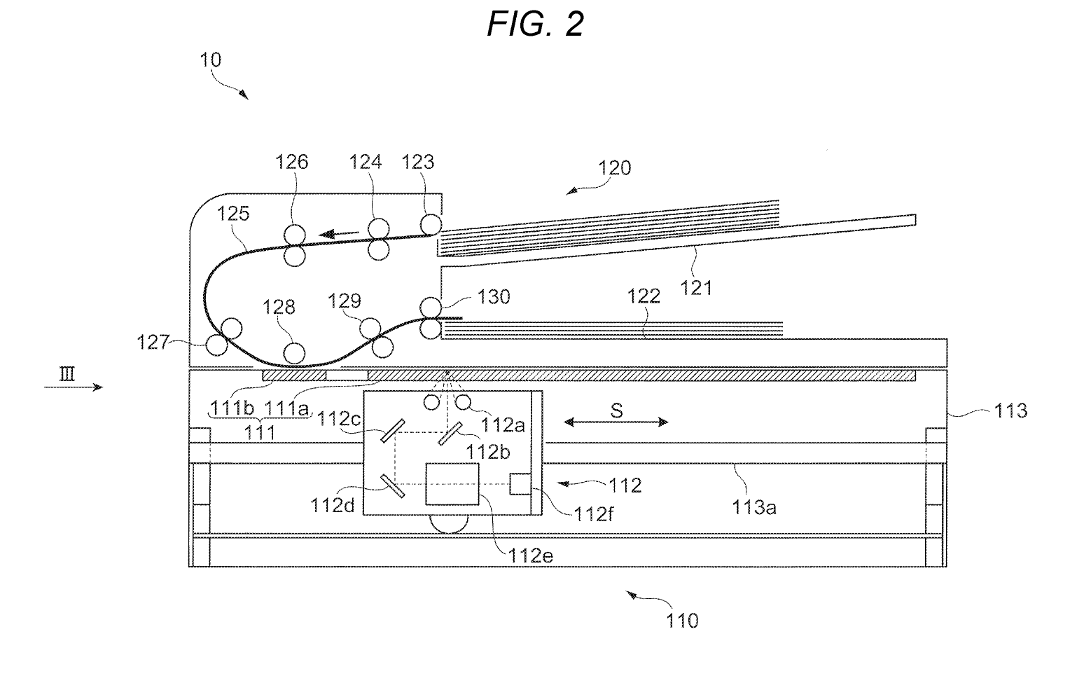

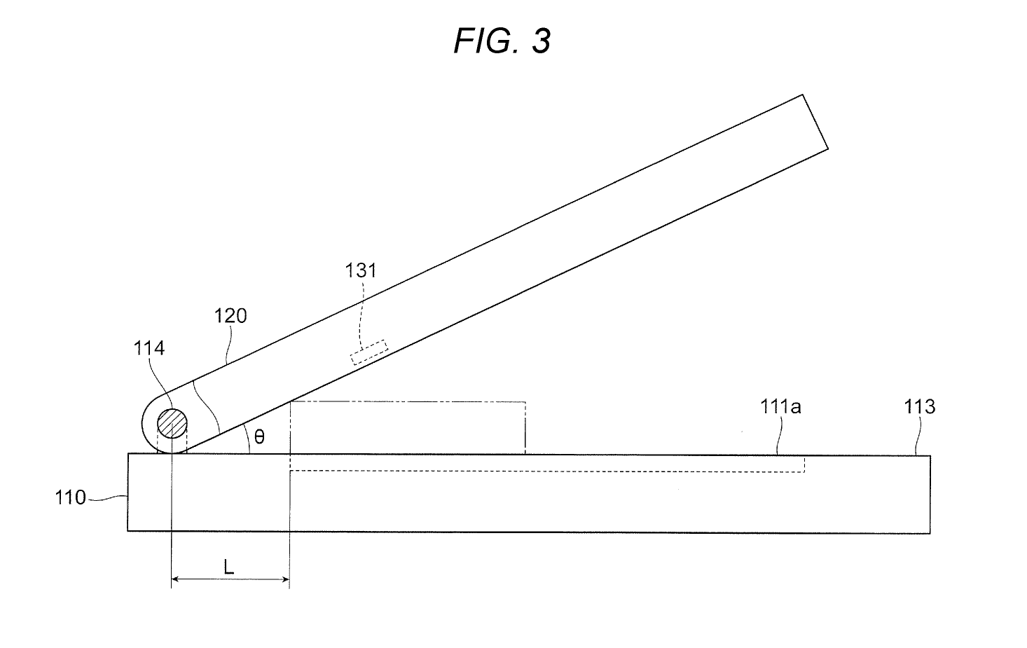

FIG. 1 is a diagram showing a general configuration of an image forming apparatus 1 according to a first exemplary embodiment. FIG. 2 is a diagram showing a general configuration of an image reading unit 10. FIG. 3 is a side view of the image reading unit 10 as viewed from direction III in FIG. 2.

The image forming apparatus 1 is equipped with the image reading unit 10 for reading the image of a document page, an image forming unit 20 for forming an image on a sheet, and a controller 30 which has a microcomputer composed of a CPU, a ROM (read-only memory), a RAM (random access memory), etc. and controls the operation of the entire image forming apparatus 1. The image forming apparatus 1 is also equipped with a user interface (UI) 40 which includes a touch panel or the like and serves to output a user instruction to the controller 30 and to present information received from the controller 30 to a user. The image forming apparatus 1 is further equipped with a sheet supply unit 50 which is disposed under the image forming unit 20 and serves to house sheets and to supply sheets to the image forming unit 20, and an ejection unit 60 which is disposed over the image forming unit 20 and serves to eject a sheet on which an image has been formed by the image forming unit 20.

### (Image Reading Unit 10)

The image reading unit 10 is equipped with a scanner 110 for reading the image of a document page by scanning it and a document feeding unit 120 for feeding document pages set therein sequentially.

The scanner unit 110 is equipped with a glass plate 111 to which a document page is brought into contact, a reading unit 112 for reading the image of a document page that is in contact with the surface of the glass plate, and a body 113 which holds the glass plate 111 and houses the reading unit 112.

The glass plate 111 has a platen glass 111a on which a document page to be subjected to image reading is placed in a stationary state and a window glass 111b which transmits light for reading of a document page being fed by the document feeding unit 120.

The reading unit 112 is equipped with illumination lamps 112a for illuminating a document page with light, a first mirror 112b for receiving reflection light coming from the document page, and plural mirrors such as a second mirror 112c and a third mirror 112d for guiding light coming from the first mirror 112b to an imaging unit. The reading unit 112 is also equipped with an image forming lens 112e for optically reducing an optical image received from the third mirror 112d and a CCD image sensor 112f for performing photoelectric conversion on an optical image formed by the image forming lens 112e. In this manner, in the reading unit 112 shown in FIG. 2, an image is formed on the CCD image sensor 112f by means of what is called a reducing optical system.

The body 113 is equipped with a guide shaft 113a which extends in an auxiliary scanning direction (indicated by arrow S in FIG. 2) and supports the reading unit 112 in such a manner that it can be moved in the auxiliary scanning direction.

The document feeding unit 120 is equipped with a document tray 121 on which plural document pages are placed and an ejected sheet tray 122 which is disposed under the document tray 121 and on which reading-completed documents pages are placed. The document feeding unit 120 is also equipped with a nudger roll 123 for picking up document pages from the document tray 121 and conveys them and separation mechanism 124 for separating the document pages into individual ones.

Disposed along a document page conveyance path 125 are preregistration rolls 126 for conveying a separated single document page toward downstream rolls and registration rolls 127 for supplying a document page to the scanner unit 110 while registering it with respect to the scanner unit 110. The document feeding unit 120 is further equipped with a platen roll 128 for helping the feeding of a document page being read by the scanner unit 110, output rolls 129 for conveying part, that has just been read by the scanner unit 110, of a document page further downward, and ejection rolls 130 for ejecting a reading-completed document page.

In the thus-configured image reading unit 10, in reading the image of a document page that is placed on the platen glass 111a and is in contact with its surface, the reading unit 112 is moved in the auxiliary scanning direction S being guided by the guide shaft 113a. During that course, the reading subject surface of the document page is illuminated with light emitted from the illumination lamps 112a and reflection light coming from the document page is reflected by the first mirror 112b, the second mirror 112c, and the third mirror 112d in this order and thereby guided to the image forming lens 112e. An image of the light is formed on the photodetecting surface of the image sensor 112f by the image forming lens 112e. The CCD image sensor 112f is a one-dimensional sensor and processes light corresponding to one line simultaneously. The document page is read in this main scanning direction while the reading unit 112 is moved in the auxiliary scanning direction S. The reading of the one document page is completed by performing this operation over the entire area of the document page.

The document feeding unit 120 is supported rotatably by the body 113 of the scanner unit 110. More specifically, the document feeding unit 120 is rotatable about a rotation shaft 114 which is attached to the body 113 of the scanner unit 110. The document feeding unit 120 serves as a pressing unit for pressing a document page placed on the platen glass 111a against it to prevent movement of the document page.

A known tilt sensor 131 for detecting a rotation angle θ of the document feeding unit 120 with respect to the body 113 of the scanner unit 110 is disposed inside the sheet ejection tray 122 of the document feeding unit 120.

### (Image Forming Unit 20)

The image forming unit 20 is equipped with component image forming units (not shown) of four colors (yellow, magenta, cyan, and black) which are arranged parallel with each other at prescribed intervals. Each component image forming unit is equipped with a photoreceptor drum (not shown), a charger (not shown) for charging the surface of the photoreceptor drum uniformly, a developing device (not shown) for visualizing an electrostatic latent image by developing it with toner, and a toner cartridge (not shown) for supplying toner of the corresponding color to the developing device.

The image forming unit 20 is also equipped with an optical system unit (not shown) for radiating laser light onto the photoreceptor drums and an intermediate transfer unit (not shown) for transferring toner images of the respective colors formed on the respective photoreceptor drums onto an intermediate transfer belt (not shown) in a multiple manner. The image forming unit 20 is further equipped with a secondary transfer unit for transfer a multiple-color toner image formed in the intermediate transfer unit to a recording medium and a fusing device (not shown) for fusing the toner image transferred to the recording sheet by heating and pressing it.

### (Sheet Supply Unit 50)

The sheet supply unit 50 is equipped with a first sheet supply unit 51 which houses first sheets P1 and supplies part of them to the image forming unit 20 and a second sheet supply unit 52 which houses second sheets P2 and supplies part of them to the image forming unit 20. For example, the first sheets P1 are A4-size sheets and the second sheets P2 are A3-size sheets.

Each of the first sheet supply unit 51 and the second sheet supply unit 52 is equipped with a sheet housing unit 56 for housing sheets and a sheet send-out roll 57 for sending out each sheet housed in the sheet housing unit 56. Each of the first sheet supply unit 51 and the second sheet supply unit 52 is also equipped with a conveyance passage 58 along which a sheet that has been sent out by the send-out roll 57 is conveyed and sets of conveying rolls 59 which are arranged along the conveyance passage 58 and serve to convey the sheet that has been sent out by the send-out roll 57 to the secondary transfer position.

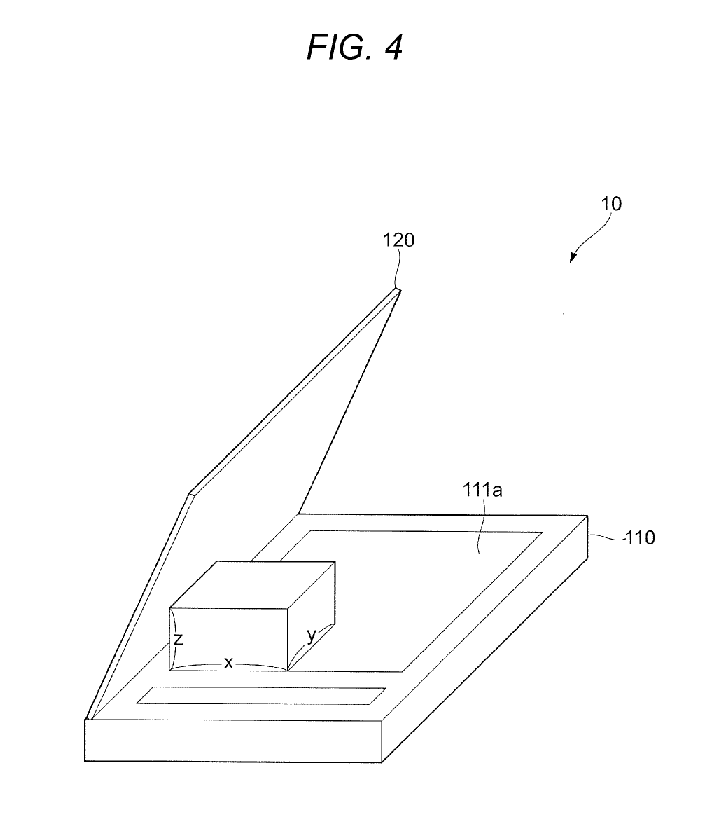

FIG. 4 shows a state that a three-dimensional object is placed on the platen glass 111a of the scanner unit 110 of the image reading unit 10. The image forming apparatus 1 having the above configuration also functions as an apparatus for printing what is to wrap a three-dimensional object that is placed on the platen glass 111a of the scanner unit 110 of the image reading unit 10. In the following description, an object that is placed on the platen glass 111a will be referred to an “object to be covered” and what is to cover the object to be covered will be referred to a “covering sheet.”

Examples of the object to be covered are a book and a gift. And examples of the covering sheet are a book cover for covering a book, a wrapping sheet for wrapping a gift, and a Japanese traditional wrapping sheet for decorating a gift.

### (Controller 30)

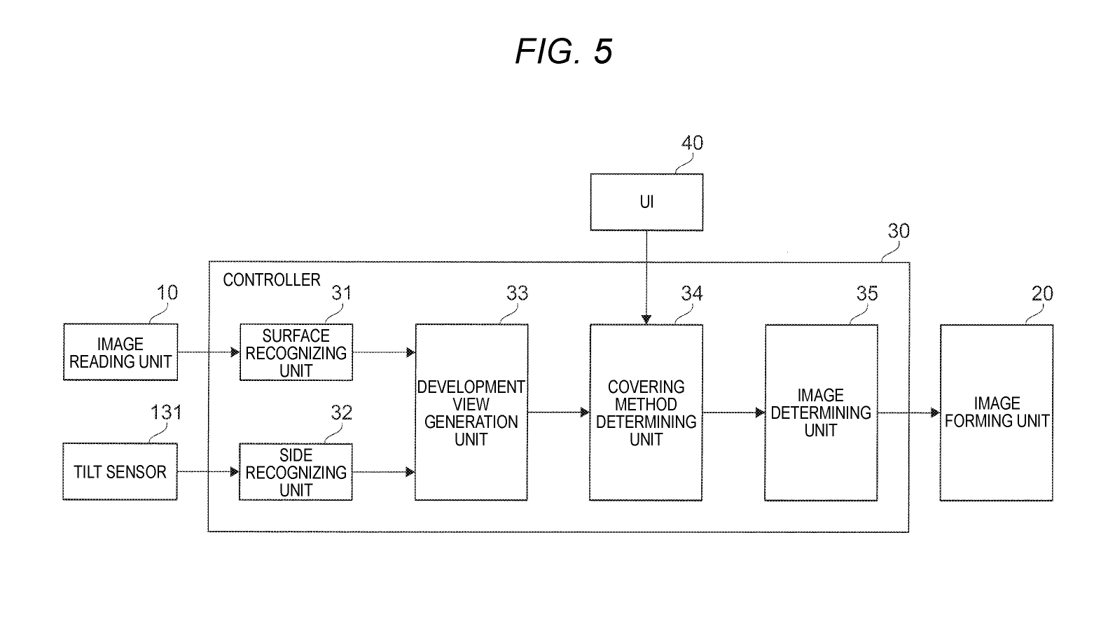

FIG. 5 is a block diagram showing the functional configuration of the controller 30. The controller 30 is equipped with a surface recognizing unit 31 for recognizing the size of a surface of an object to be covered, a side recognizing unit 32 for recognizing the length of one side of the object to be covered, and a development view generation unit 33 for generating a development view of the object to be covered. The controller 30 is also equipped with a covering method determining unit 34 for selecting a method for covering an object to be covered and an image determining unit 35 for determining an image to be formed on a sheet.

### <<Surface Recognizing Unit 31>>

The surface recognizing unit 31 recognizes a size (=x×y) of a surface opposed to the platen glass 111a (i.e., in contact with the platen glass 111a) of an object to be covered on the basis of an image obtained by reading the object to be covered that is placed on the platen glass 111a by the reading unit 112 of the scanner unit 110. The surface recognizing unit 31 recognizes a size of an image read by the reading unit 112 as a size (=x×y) of a surface in contact with the platen glass 111a of the object to be covered.

The surface recognizing unit 31 judges whether an object to be covered is placed adjacent to a prescribed position on the basis of an image obtained by reading the object to be covered by the reading unit 112. An example of the prescribed position is one of the four corners of the platen glass 111a. For example, the surface recognizing unit 31 judges that an object to be covered is placed adjacent to the prescribed position if one side of one surface of the object to be covered coincides with one of the two lines that form one of the four corners of the platen glass 111a and another side of the object to be covered coincides with the other of the two lines that form the one corner.

### <<Side Recognizing Unit 32>>

The side recognizing unit 32 recognizes a rotation angle θ of the document feeding unit 120 on the basis of an output value of the tilt sensor 131 which is disposed inside the document feeding unit 120, and recognizes a thickness of the object to be covered placed on the platen glass 111a (i.e., a length (=z) in the direction that is perpendicular to its surface that is in contact with the platen glass 111a) on the basis of the recognized rotation angle θ. Where the object to be covered is placed adjacent to the prescribed position, a distance L from the rotation center of the document feeding unit 120 to the surface opposed to the platen glass 111a of the object to be covered is constant. Thus, the side recognizing unit 32 recognizes the thickness (=z) of the object to be covered according to an equation z=L×tan θ.

To measure the thickness of the object to be covered, it is appropriate for the side recognizing unit 32 to cause display, on the display of the UI 40, of a message for urging a user to make a manipulation for pressing the object to be covered that is placed on the platen glass 111a against the platen glass 111a using the document feeding unit 120.

The following description will be directed to the case that the side recognizing unit 32 is used as a means for recognizing the thickness of the object to be covered (i.e., the length (=z) in the direction that is perpendicular to its surface that is in contact with the platen glass 111a). Alternatively, the thickness of the object to be covered may be recognized using the surface recognizing unit 31 or causing a user to input information indicating the thickness of the object to be covered through the UI 40.

An appropriate technique for recognizing the thickness of the object to be covered using the surface recognizing unit 31 is as follows. The surface recognizing unit 31 reads a surface other than the surface whose size (=x×y) has been recognized by itself, and recognizes a size (e.g., x×z or y×z) of the other surface on the basis of a resulting image of the other surface. Then the side recognizing unit 32 acquires information indicating the size of the other surface from the surface recognizing unit 31 and thereby recognizes the thickness of the object to be covered.

### <<Development View Generation Unit 33>>

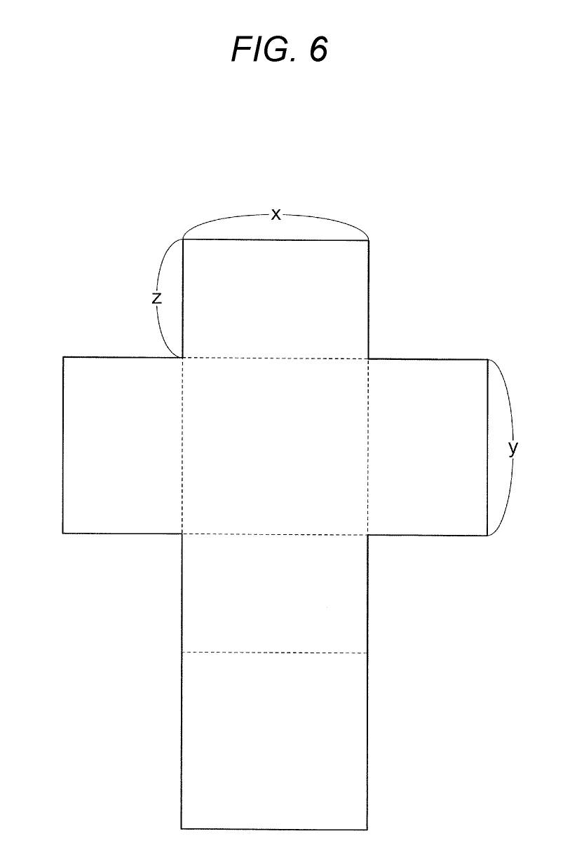

FIG. 6 shows a development view of the object to be covered. The development view generation unit 33 generates development view information of the object to be covered on the basis of the size (=x×y; recognized by the surface recognizing unit 31) of the surface in contact with the platen glass 111a of the object to be covered and the thickness (i.e., the length (=z) in the direction that is perpendicular to the surface that is in contact with the platen glass 111a; recognized by the side recognizing unit 32) of the object to be covered. For example, the development view generation unit 33 generates development view information with an assumption that an object to be covered is a cuboid.

### <<Covering Method Determining Unit 34>>

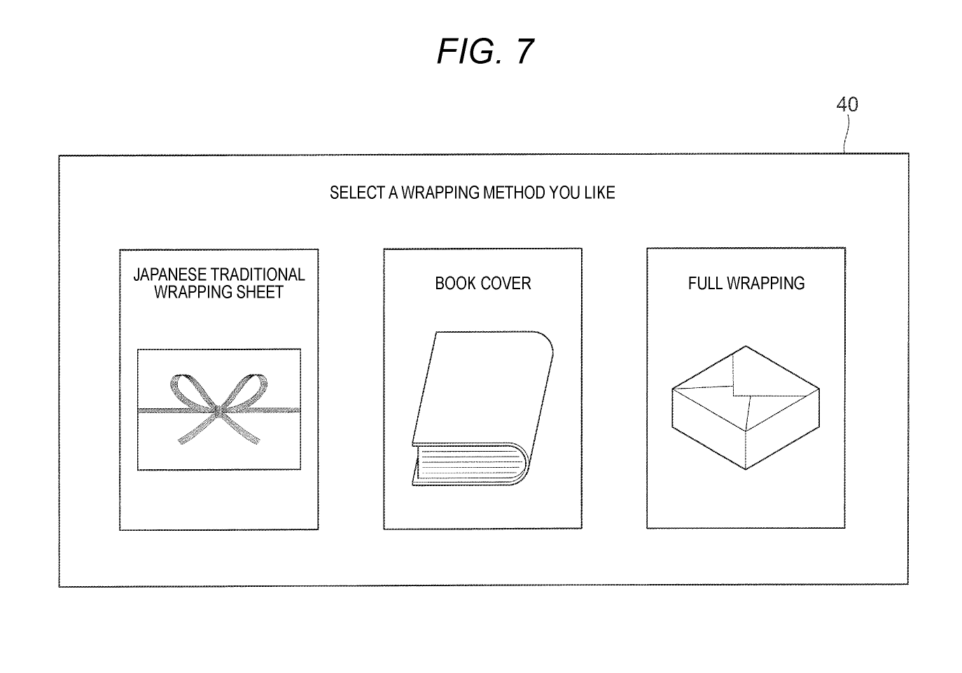

FIG. 7 shows an example covering method selection picture to be displayed on the UI 40. The covering method determining unit 34 determines a method for covering the object to be covered on the basis of an output of the UI 40. First, the covering method determining unit 34 causes display, on the display of the UI 40, of a covering method selection picture shown in FIG. 7 that allows a user to select from preset covering methods. In the exemplary embodiment, covering with a Japanese traditional wrapping sheet, covering with a book cover, and full wrapping with a sheet are set as covering methods. The covering method determining unit 34 causes display, on the display of the UI 40, of icons accompanied by words “Japanese traditional wrapping sheet,” “book cover,” and “full wrapping,” respectively, and thereby urges the user to select one of them.

The covering method determining unit 34 tentatively employs, as a covering method, the method of an icon selected by the user. That is, if the icon accompanied by the words “Japanese traditional wrapping sheet” is pushed, the covering method determining unit 34 tentatively employs covering with a Japanese traditional wrapping sheet as a method for covering the object to be covered. If the icon accompanied by the words “book cover” is pushed, the covering method determining unit 34 tentatively employs covering with a book cover as a method for covering the object to be covered.

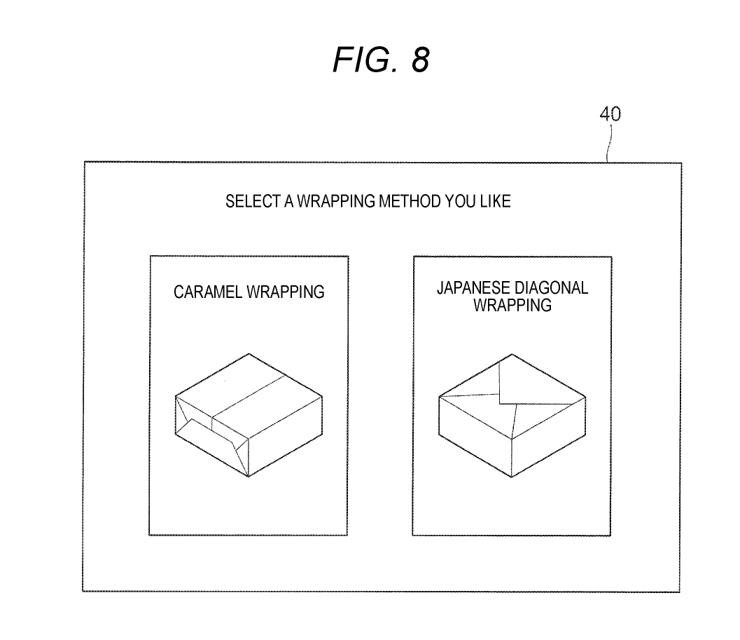

FIG. 8 shows an example full wrapping method selection picture to be displayed on the UI 40. If the icon accompanied by the words “full wrapping” is pushed, the covering method determining unit 34 causes display, on the display of the UI 40, of icons accompanied by words “caramel wrapping” and “Japanese diagonal wrapping,” respectively, and thereby urges the user to select one of them. If the icon accompanied by the words “caramel wrapping” is pushed, the covering method determining unit 34 tentatively employs caramel wrapping as a method for covering the object to be covered. On the other hand, if the icon accompanied by the words “Japanese diagonal wrapping is pushed, the covering method determining unit 34 tentatively employs Japanese diagonal wrapping as a method for covering the object to be covered.

After tentatively determining a method for covering the object to be covered, the covering method determining unit 34 finally determines a covering method on the basis of the tentatively determined covering method, the sheet sizes of the sets of sheets housed in the sheet supply unit 50, and the development view information of the object to be covered generated by the development view generation unit 33.

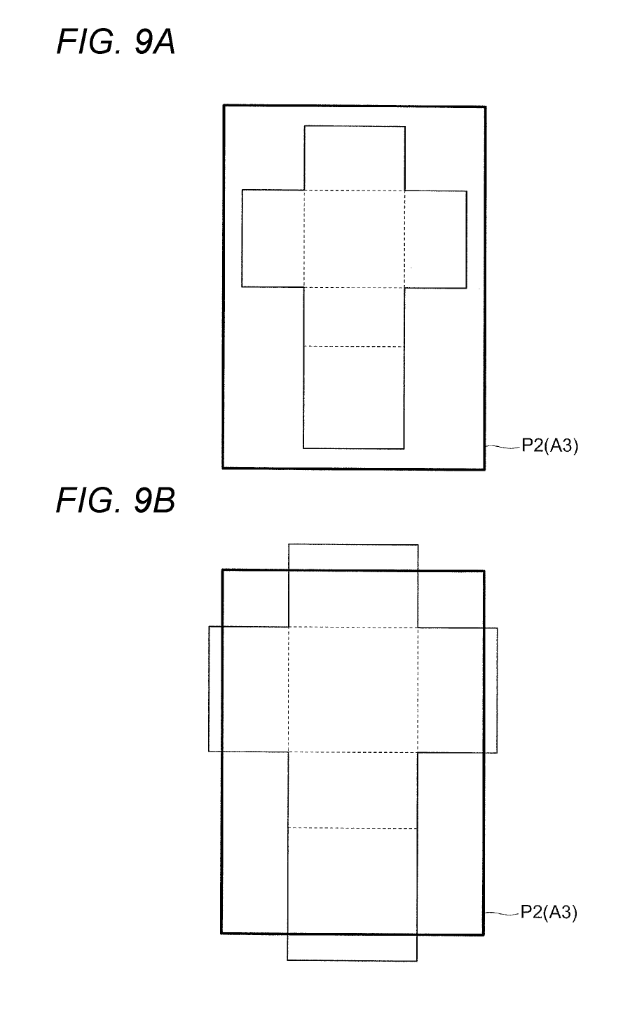

FIG. 9A shows a case that the development view of the object to be covered is within a sheet size, and FIG. 9B a case that the development view of the object to be covered is not within a sheet size.

If the tentatively determined covering method is covering with a book cover or full wrapping and the development view that is recognized from the development view information of the object to be covered generated by the development view generation unit 33 falls within a sheet size of sheets housed in a sheet housing unit 56 (see FIG. 9A), the covering method determining unit 34 judges that a sheet housed in the sheet housing unit 56 can be used as a covering sheet and employs the tentatively determined covering method as a final covering method. The covering method determining unit 34 employs, as a sheet type for image formation, a sheet type having a smallest size among sheet types whose sheet sizes are large enough to contain the development view of the object to be covered.

Since pieces of sheet information of the sets of sheets housed in the respective sheet housing units 56 of the first sheet supply unit 51 and the second sheet supply unit 52 are stored in the ROM, the covering method determining unit 34 acquires from the ROM the pieces of sheet information of the sets of sheets housed in the respective sheet housing units 56.

On the other hand, if the tentatively determined covering method is covering with a book cover or full wrapping and the development view that is recognized from the development view information of the object to be covered generated by the development view generation unit 33 does not fall within a sheet size of any set of sheets housed in the sheet housing units 56 (see FIG. 9B), the covering method determining unit 34 judges that no sheet housed in the sheet housing units 56 can be used as a covering sheet with the currently selected covering method. Thus, the covering method determining unit 34 announces, through the UI 40, that with the currently selected covering method the object to be covered does not fall within any sheet size. And the covering method determining unit 34 presents other covering methods to the user.

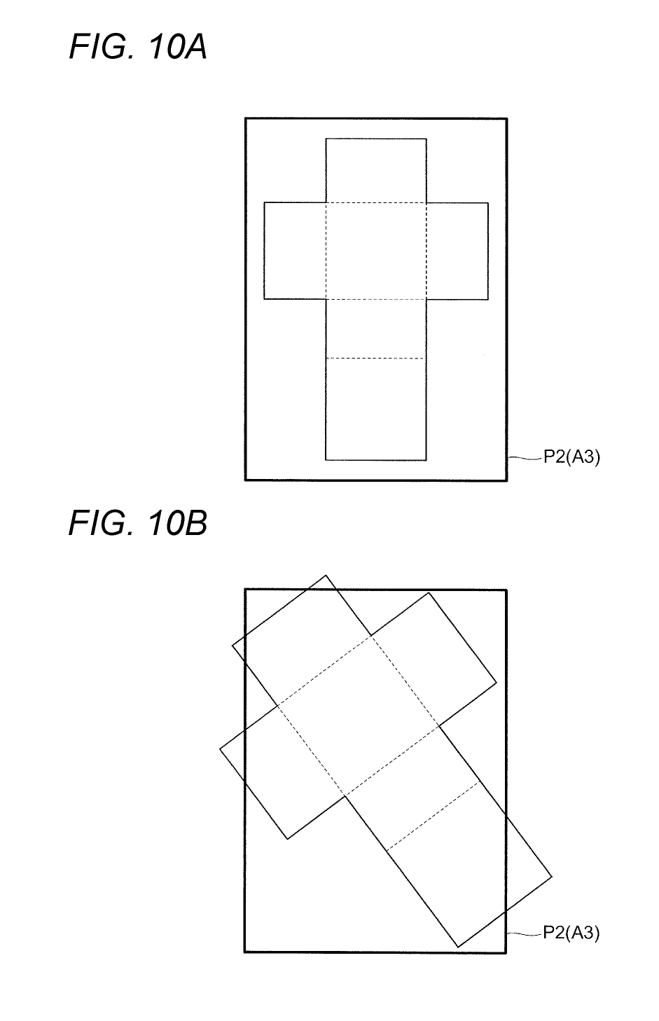

FIG. 10A shows a relationship between a development view for caramel wrapping and a sheet size, and FIG. 10B shows a relationship between a development view for Japanese diagonal wrapping and a sheet size.

For example, if the tentatively determined covering method is Japanese diagonal wrapping and the object to be covered does not fall within any sheet size in the case of Japanese diagonal wrapping (see FIG. 10B) but falls within a sheet size in the case of caramel wrapping (see FIG. 10A), the covering method determining unit 34 causes the UI 40 to display a message to the effect that the object to be covered does not fall within the maximum sheet size (in the exemplary embodiment, A3 size) in the case of Japanese diagonal wrapping but falls within the maximum sheet size in the case of caramel wrapping (i.e., recommends caramel wrapping).

If the tentatively determined covering method is full wrapping and the object to be covered does not fall within the maximum sheet size in either case of caramel wrapping or Japanese diagonal wrapping but falls within the maximum sheet size in the case of covering with a Japanese traditional wrapping sheet, the covering method determining unit 34 causes the UI 40 to display a message to the effect that the object to be covered does not fall within the maximum sheet size with the currently selected covering method but falls within the maximum sheet size in the case of covering with a Japanese traditional wrapping sheet (i.e., recommends covering with a Japanese traditional wrapping sheet).

If the user selects the covering method that is recommended through the UI 40, the covering method determining unit 34 decides on the selected covering method as a final covering method. The covering method determining unit 34 decides on, as a sheet type for image formation, a sheet type having a smallest size among sheet types whose sheet sizes are large enough to enable use of the recommended covering method.

If the tentatively determined covering method is covering with a book cover or full wrapping and the development view recognized from the development view information of the object to be covered generated by the development view generation unit 33 falls within the minimum sheet size (in the exemplary embodiment, A4 size) among the sheet sizes of the sets of sheets housed in the sheet supply unit 50 only marginally (i.e., with only small margins), the covering method determining unit 34 may cause the UI 40 to display a message to the effect that with the currently selected covering method the object to be covered falls within the minimum sheet size with only small margins and recommend a sheet size (in the exemplary embodiment, A3 size) that is larger than the minimum sheet size.

If the user selects the sheet size that is recommended through the UI 40, the covering method determining unit 34 decides on the selected sheet type as a sheet type for image formation.

If with the currently selected covering method the object to be covered falls within the maximum sheet size falls within the maximum sheet size (in the exemplary embodiment, A3 size) and does not fall within a sheet size (in the exemplary embodiment, A4 size) that is smaller than the maximum sheet size with only small shortages, the covering method determining unit 34 may cause display of a message to that effect and recommend the sheet size that is smaller than the maximum sheet size.

If the user selects the sheet size that is recommended through the UI 40, the covering method determining unit 34 decides on the selected sheet type having the selected sheet size as a sheet type for image formation.

If the tentatively determined covering method is covering with Japanese traditional wrapping sheet, the covering method determining unit 34 judges whether a sheet type exists whose longer side is longer than the middle one (whose length is y if x>y>z) of the three sides of the cuboid object to be covered. If such a sheet type exists, the covering method determining unit 34 decides on that sheet type as a sheet type for image formation. If plural such sheet types exist, the covering method determining unit 34 decides on a sheet type having a smallest size (in the exemplary embodiment, A4 size) among those sheet types as a sheet type for image formation. On the other hand, if there exists no such sheet type, the covering method determining unit 34 announces, through the UI 40, that no sheet type exists that can be used for covering with a Japanese traditional wrapping sheet.

### <<Image Determining Unit 35>>

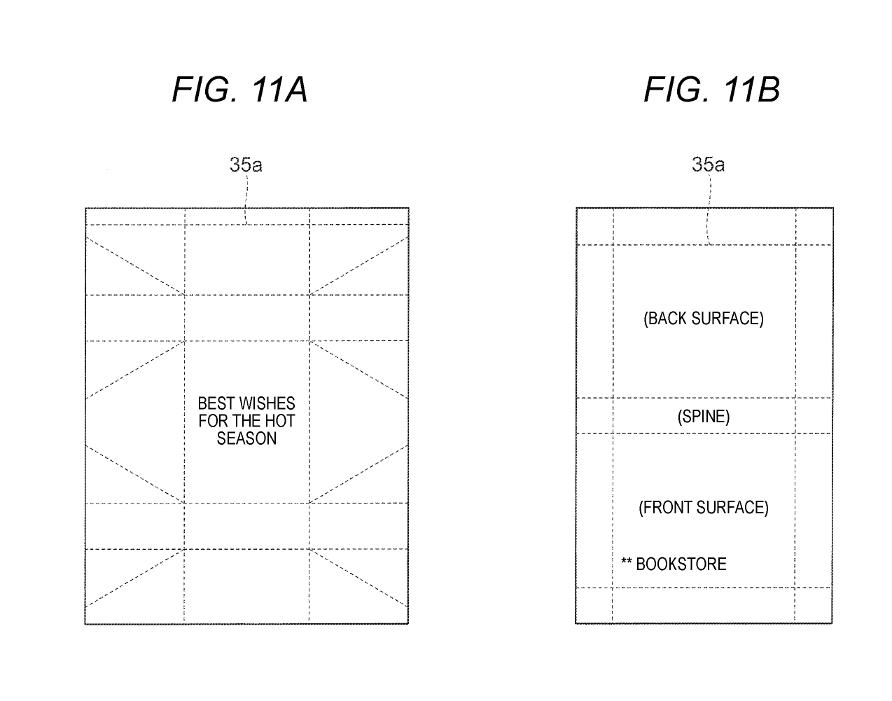

FIGS. 11A and 11B show example images formed on sheets. FIG. 11A shows an example image that is formed in a case that the covering method is caramel wrapping, and FIG. 11B shows an example image that is formed in a case that the covering method is covering with a book cover.

The image determining unit 35 determines, as an image to be formed on an output sheet, an image that corresponds to the covering method determined by the covering method determining unit 34 and includes folding lines, a word(s), etc. For example, the image determining unit 35 calculates positions of folding lines on the basis of the covering method determined by the covering method determining unit 34 and the development view information of the object to be covered determined by the development view generation unit 33, and determines an image (to be formed on a sheet) that includes broken lines 35a as folding lines (see FIGS. 11A and 11B). Although in FIGS. 11A and 11B the broken lines 35a as the folding lines are drawn in black, there are no limitations on the color of the broken lines 35a; they may be formed as transparent lines using a clear toner.

The image determining unit 35 may employ, as an image to be formed on a sheet, a word(s) or a figure that is selected by the user through the UI 40. An example word(s) and figure are ones to be input by the user through the UI 40. An example word(s) to be input by the user through the UI 40 is a word(s) to be written on a book cover, such as “** Bookstore” (see FIG. 11B).

An image be formed on a sheet may be a word(s) or a figure that is selected by the user from words and figures displayed on the display of the UI 40. Example words to be displayed on the display of the UI 40 by the image determining unit 35 are words that are commonly used as terms to be written on the front surface of a Japanese traditional wrapping sheet, such as “Best wishes for the hot season,” “Year-end gift,” “Congratulations,” “Gratitude,” and “Felicitations” (see FIG. 11A).

It is appropriate for the image determining unit 35 to employ, as a position and a direction at and in which a word(s) or a figure to be formed on a sheet, ones selected by the user through the UI 40. For example, it is appropriate for the image determining unit 35 to cause the UI 40 to display a development view on the basis of the development view information of the object to be covered generated by the development view generation unit 33 and employ, as a position where to form a word(s) or a figure, a surface selected using the displayed development view. The image determining unit 35 may be configured so as to enable selection of a specific portion of a selected surface, such as selection from a central portion, a top portion, and a bottom portion or selection from a central portion, a center-right portion, a center-left portion, a top-right portion, a top-left portion, a bottom-right portion, and a bottom-left portion.

It is also appropriate for the image determining unit 35 to allow the user to select a specific direction in which to form a word(s) or a figure, such as a direction that is parallel with the longer side of a selected surface or a direction that is parallel with the shorter side of a selected surface. FIG. 11A shows a case that words are formed at the center in a selected surface parallel with its longer side.

Where the covering method is covering with a book cover and a development view is to be displayed on the UI 40 on the basis of the development view information of the object to be covered generated by the development view generation unit 33, it is appropriate for the image determining unit 35 to arrange the surface so that the spine is located between the front surface and the back surface as shown in FIG. 11B.

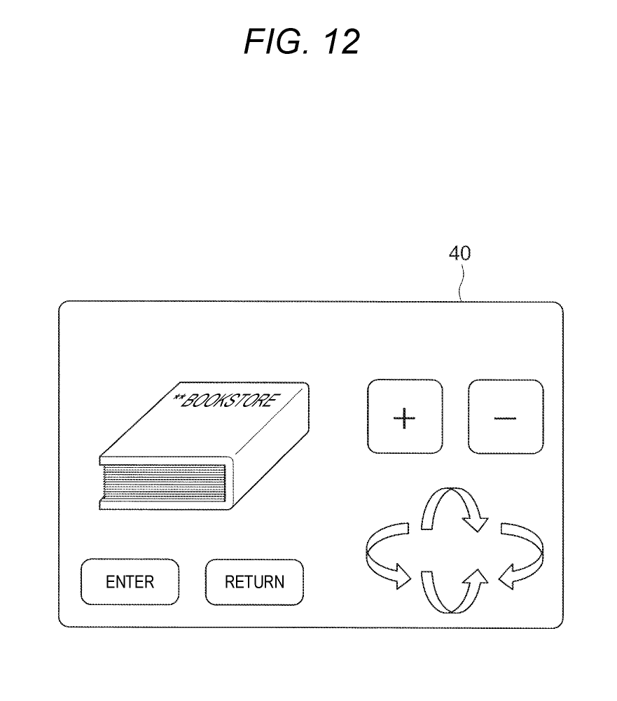

FIG. 12 shows an example preview picture to be displayed on the UI 40. When a position and a direction at and in which a word(s) or a figure (i.e., image) that should be formed on a sheet has been determined, the image determining unit 35 may display, on the display of the UI 40, an image that the object to be covered is covered with a covering sheet and thereby urge the user to make a final decision. As shown in FIG. 12, it is appropriate for the image determining unit 35 to display icons labeled “Enter” and “Return,” respectively, icons for image enlargement and reduction that are labeled “+” and “−,” respectively, icons indicating respective image rotation directions, etc. in the preview picture together with the image of the covering sheet.

The image determining unit 35 may employ, as an image to be formed on a sheet, an image read by the image reading unit 10. For example, it is appropriate for the image determining unit 35 to cause the UI 40 to display a development view on the basis of the development view information of the object to be covered generated by the development view generation unit 33, urge the user to select a surface on which to form an image to be read by the image reading unit 10, and request the user to place, on the platen glass 111a, a thing on which the image is formed and have the image reading unit 10 read the image. After reading of the image by the image reading unit 10, it is also appropriate for the image determining unit 35 to cause the UI 40 to display a preview picture in which a thumbnail of the image read by the image reading unit 10 is formed in the surface selected by the user.

The image determining unit 35 finally decides on the image to be formed on a sheet when the user has pushed the icon labeled “Enter” in the preview picture being displayed in the UI 40. The image determining unit 35 outputs commands to the image forming unit 20 and the sheet supply unit 50 so that the image determined by the image determining unit 35 will be formed on a sheet of the sheet type (first sheet P1 or second sheet P2) determined by the covering method determining unit 34.

As described above, according to a first aspect of the invention, the image forming apparatus (1) functions as a development view information generation device which is equipped with the scanner unit 110 (example reading unit) that generates a flat surface image by reading a flat surface; the surface recognizing unit 31 (example first recognizing unit) that recognizes first dimensions (x and y) that are dimensions of one of flat surfaces of a three-dimensional object using the flat surface image generated by the scanner unit 110; the side recognizing unit 32 (example second recognizing unit) that recognizes a second dimension (=z) in a direction that crosses the one flat surface of the three-dimensional object; and the development view generation unit 33 (example generation unit) that generates development view information of the three-dimensional object using the first dimensions and the second dimension. The thus-configured image forming apparatus (1) can easily generate development view information of an object to be covered (three-dimensional object) that is necessary in producing a covering sheet (e.g., wrapping sheet) for covering the object to be covered.

The image forming apparatus (1) is further equipped with the tilt sensor 131 (example detection unit) that detects a rotation angle of the document feeding unit 120 (an example member that is supported so as to be rotatable with respect to the scanner unit 110), and the side recognizing unit 32 recognizes a thickness (=z) of the object to be covered using the rotation angle θ detected by the tilt sensor 131. These measures make it possible to generate development view information of an object to be covered more easily than in a configuration in which a thickness (=z) of an object to be covered is recognized on the basis of, for example, information that is input manually by a user.

The image forming apparatus (1) also functions as a wrapping sheet output apparatus which is equipped with the sheet housing unit(s) 56 (example housing unit) that houses sheets; the scanner unit 110; the surface recognizing unit 31; the side recognizing unit 32; the development view generation unit 33; and the image determining unit 35 (example output unit) that outputs, as a wrapping sheet for wrapping the three-dimensional object, one of the sheets housed in the sheet housing unit(s) 56 on the basis of dimensional information of the sheets housed in the sheet housing unit(s) 56 and the development view information generated by the development view generation unit 33.

The thus-configured image forming apparatus (1) can easily generate development view information of an object to be covered (three-dimensional object) that is necessary in producing a wrapping sheet for wrapping the object to be covered, and can easily output such a wrapping sheet. Using the image forming apparatus (1), a user can obtain a wrapping sheet easily because he or she need not input instructions manually or have the scanner unit 110 perform reading operations repeatedly.

As described above, according to a second aspect of the invention, the image forming apparatus (1) functions as a wrapping sheet output apparatus which is equipped with the sheet housing unit(s) 56 (example housing unit) that houses sheets; the development view generation unit 33 (example recognizing unit) that recognizes dimensions of an object to be wrapped (example object to be covered); and the covering method determining unit 34 (example judging unit) that judges whether the sheets housed in the sheet housing unit(s) 56 can be used as a wrapping sheet for wrapping the object to be wrapped on the basis of dimensions of the sheets housed in the sheet housing unit(s) 56 and the dimensions of the object to be wrapped recognized by the development view generation unit 33. The thus-configured image forming apparatus (1) can automatically output a sheet that can be used as a wrapping sheet.

The development view generation unit 33 generates a development view on the basis of the recognized dimensions, and the covering method determining unit 34 judges that the sheets housed in the sheet housing unit(s) 56 can be used as a wrapping sheet if the development view of the object to be wrapped falls within a size of the sheets housed in the sheet housing unit(s) 56. With these measures, the covering method determining unit 34 can judge, with high accuracy, whether the sheets housed in the sheet housing unit(s) 56 can be used as a wrapping sheet.

The sheet housing units 56 house plural sets of sheets having different sizes (first sheets 21 and second sheets P2), respectively, and the covering method determining unit 34 judges that the plural sets of sheets housed in the sheet housing units 56 cannot be used as a wrapping sheet if the development view of the object to be wrapped does not fall within a maximum one of sizes of the plural sets of sheets. With these measures, the covering method determining unit 34 can judge, with high accuracy, whether one of the sets of sheets housed in the sheet housing unit(s) 56 can be used as a wrapping sheet.

The image forming apparatus (1) is further equipped with the UI 40 (example receiving unit) that receives an instruction indicating one of plural wrapping methods from a user. The covering method determining unit 34 judges, for each of the plural wrapping methods, whether the sheets housed in the sheet housing unit(s) 56 can be used as a wrapping sheet, and, if judging that the sheets housed in the sheet housing unit(s) 56 cannot be used as a wrapping sheet with the wrapping method indicated by the instruction received by the UI 40 but can be used as a wrapping sheet with another of the plural wrapping methods, presents the other wrapping method to the user. With these measures, a user need not select a sheet type by himself or herself taking dimensions of an object to be wrapped into consideration and hence can obtain a wrapping sheet easily.

The image forming apparatus (1) according is further equipped with the image determining unit 35 (example image adding unit) that adds an image to the wrapping sheet. This makes it possible add a word(s) or a figure that conforms to a user's tastes to a wrapping sheet. For example, it is appropriate for the image determining unit 35 to add, to the wrapping sheet, broken lines 35a (example folding lines) to be referred to in wrapping the object to be wrapped. The addition of the broken lines 35a to the wrapping sheet as folding lines allows the user to easily wrap the object to be wrapped.

Incidentally, in the above-described image forming apparatus 1 according to the exemplary embodiment, if the development view of the object to be covered does not fall within any of the sheet sizes of the sets of sheets housed in the sheet supply unit 50 with a covering method selected by the user through the UI 40 but falls within the sheet size of a certain set of sheets housed in the sheet supply unit 50 with another covering method, the covering method determining unit 34 may change the covering method to the other one automatically. For example, if the development view of the object to be covered does not fall within the A3 size with Japanese diagonal wrapping selected by the user but falls within the A3 size with caramel wrapping, the covering method determining unit 34 may change the covering method to caramel wrapping automatically.

Furthermore, in the above-described image forming apparatus 1 according to the exemplary embodiment, not only does the image determining unit 35 cause the UI 40 to display a word(s) or a figure stored in the ROM but also it may cause the UI 40 to display a word(s) or a figure that is stored in an HDD (hard disk drive) of the image forming apparatus 1 or a server with which it can communicate over a communication means such as the Internet.

### Exemplary Embodiment 2

An image forming apparatus according to a second exemplary embodiment is different from the image forming apparatus 1 according to the first exemplary embodiment in the mechanism for detecting a rotation angle θ of the document feeding unit 120. Differences from the first exemplary embodiment will be described below.

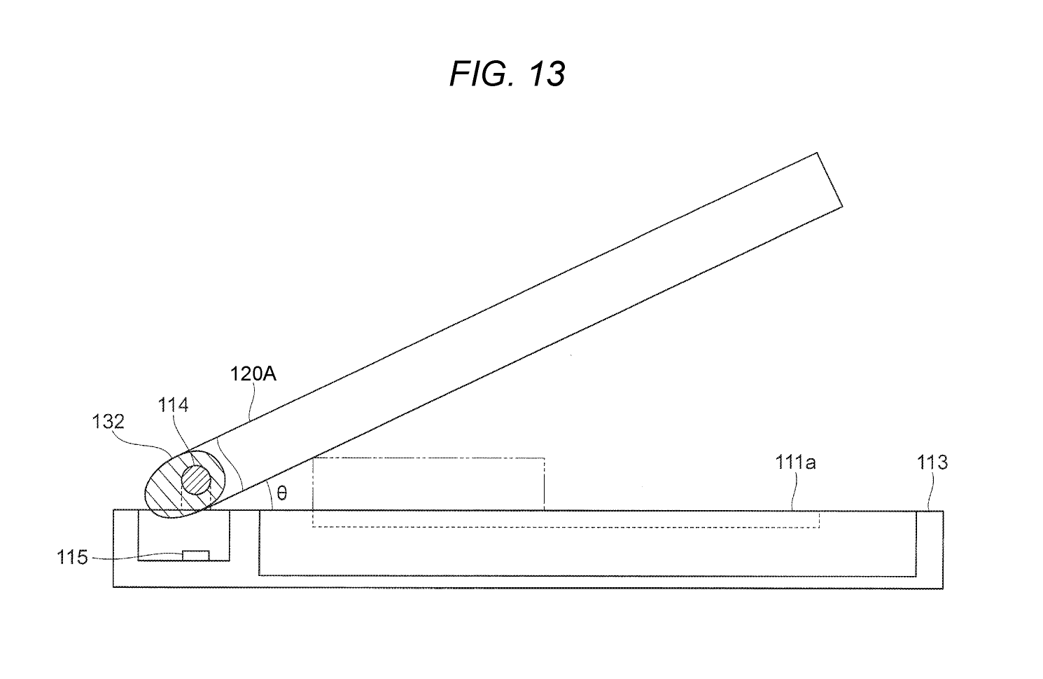

FIG. 13 is a side view, as viewed from the direction corresponding to direction III in FIG. 2, of an image reading unit employed in the second exemplary embodiment. A document feeding unit 120A employed in the second exemplary embodiment is equipped with a rotary member 132 which is rotatable about the rotation shaft 114 attached to the body 113 of the scanner unit 110 and has a curved surface whose distance from the rotation center varies depending on the rotation angle.

The scanner unit 110 is equipped with a distance detection sensor 115 which is disposed at such a position as to be opposed to the curved surface of the rotary member 132 and serves to detect a distance to the curved surface of the rotary member 132.

In the second exemplary embodiment, the side recognizing unit 32 recognizes a rotation angle θ of the document feeding unit 120A on the basis of an output value (i.e., information indicating a distance to the curved surface of the rotary member 132) of the distance detection sensor 115 disposed in the scanner unit 110 and recognizes a thickness of an object to be covered placed on the platen glass 111a (i.e., a length (=z) in the direction that is perpendicular to its surface that is in contact with the platen glass 111a) on the basis of the recognized rotation angle θ.

In the above-configured image forming apparatus according to the second exemplary embodiment, the distance detection sensor 115 detects a distance to the curved surface of the rotary member 132 with high accuracy even in a case that the document feeding unit 120A is so low in stiffness that an inclination angle of its rotation-center-side portion is different from that of its tip-side portion and hence the tilt sensor 131 could not detect a rotation angle θ accurately even if it were disposed inside the document feeding unit 120A.

As such, the side recognizing unit 32 can recognize a thickness (=z) of an object to be covered with high accuracy by recognizing a rotation angle of the document feeding unit 120A with high accuracy. It is not necessary to increase the stiffness of the document feeding unit 120. This lowers the probability that an object to be covered is deformed in measuring its thickness because of increased stiffness of the document feeding unit 120A.

### Exemplary Embodiment 3

An image forming apparatus according to a third exemplary embodiment is different from the image forming apparatus according to the second exemplary embodiment in that the former is equipped with a measuring member 140 for measuring a thickness of an object to be covered. Differences from the second exemplary embodiment will be described below.

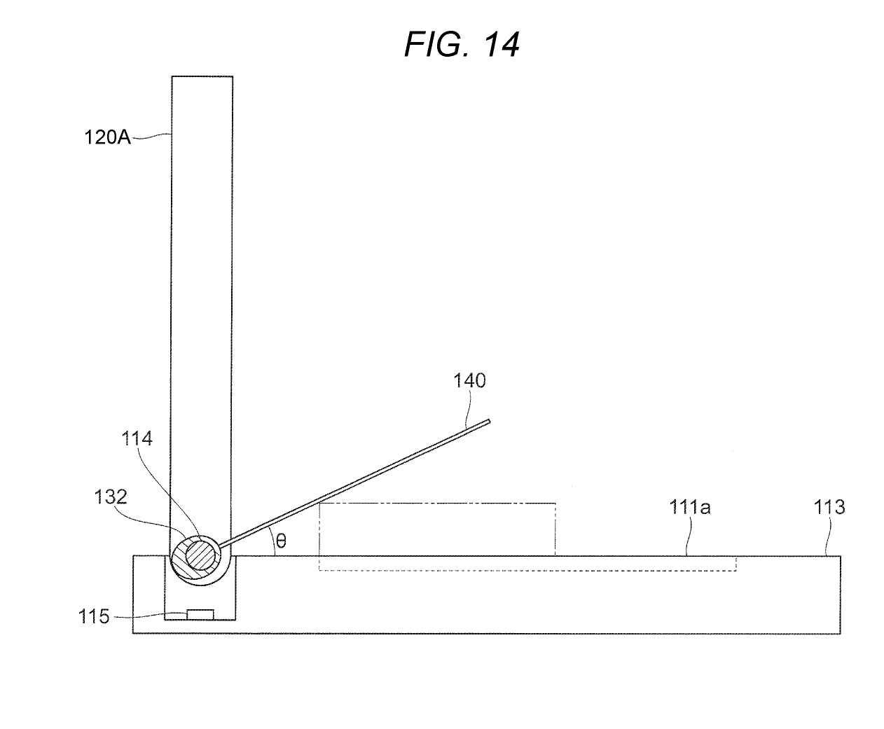

FIG. 14 is a side view, as viewed from the direction corresponding to direction III in FIG. 2, of an image reading unit employed in the third exemplary embodiment. The image reading unit employed in the third exemplary embodiment is equipped with the measuring member 140 which is rotatable about the rotation shaft 114. The rotary member 132 which is formed with the curved surface whose distance from the rotation center varies depending on the rotation angle is rotated about the rotation shaft 114 together with the measuring member 140.

In the third exemplary embodiment, the side recognizing unit 32 recognizes a rotation angle θ of the measuring member 140 on the basis of an output value (i.e., information indicating a distance to the curved surface of the rotary member 132) of the distance detection sensor 115 disposed in the scanner unit 110 and recognizes a thickness of an object to be covered placed on the platen glass 111a (i.e., a length (=z) in the direction that is perpendicular to its surface that is in contact with the platen glass 111a) on the basis of the recognized rotation angle θ.

In the above-configured image forming apparatus according to the third exemplary embodiment, the probability that an object to be covered is deformed in measuring its thickness is lowered by setting the stiffness of the measuring member 140 lower than that of the document feeding unit 120A.

In the image forming apparatus (1) according to the first to third exemplary embodiments, the side recognizing unit 32 may recognize a thickness (=z) of an object to be covered by receiving information that is input manually by a user through the UI 40. Furthermore, the side recognizing unit 32 may recognize a thickness (=z) of an object to be covered on the basis of an image obtained by reading, with the scanner unit 110, a surface that is different from a surface whose size (=x×y) is recognized by the surface recognizing unit 31.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A development view information generation device comprising:
a reading unit that generates a flat surface image by reading a flat surface;
a first recognizing unit that recognizes first dimensions that are dimensions of one of flat surfaces of a three-dimensional object using the flat surface image generated by the reading unit;
a second recognizing unit that recognizes a second dimension in a direction that crosses the one flat surface of the three-dimensional object; and
a generation unit that generates development view information of the three-dimensional object using the first dimensions and the second dimension.

2. The development view information generation device according to claim 1, further comprising a detection unit that detects a rotation angle of a member that is supported so as to be rotatable with respect to the reading unit,
wherein the second recognizing unit recognizes the second dimension using the rotation angle detected by the detection unit.

3. The development view information generation device according to claim 1, wherein:
the reading unit has a placement member on which to place the three-dimensional object, and reads an image of a flat surface, in contact with the placement member, of the three-dimensional object; and
the first recognizing unit recognizes, as the first dimensions, dimensions of the flat surface in contact with the placement member.

4. The development view information generation device according to claim 1, wherein the second recognizing unit recognizes the second dimension using the first recognizing unit.

5. A wrapping sheet output apparatus comprising:
a housing unit that houses sheets;
a reading unit that generates a flat surface image by reading a flat surface;
a first recognizing unit that recognizes first dimensions that are dimensions of one of flat surfaces of a three-dimensional object using the flat surface image generated by the reading unit;
a second recognizing unit that recognizes a second dimension in a direction that crosses the one flat surface of the three-dimensional object;
a generation unit that generates development view information of the three-dimensional object using the first dimensions and the second dimension; and
an output unit that outputs, as a wrapping sheet for wrapping the three-dimensional object, one of the sheets housed in the housing unit based on dimensional information of the sheets housed in the housing unit and the development view information.

6. The wrapping sheet output apparatus according to claim 5, wherein the output unit outputs one of the sheets housed in the housing unit as the wrapping sheet if a development view of the three-dimensional object falls within a size of the sheets.

7. The wrapping sheet output apparatus according to claim 6, further comprising a receiving unit that receives an instruction indicating one of plural wrapping methods from a user,
wherein the output unit judges, for each of the plural wrapping methods, whether the development view of the three-dimensional object falls within the size of the sheets housed in the housing unit, and outputs one of the sheets as the wrapping sheet if judging that the development view does not fall within the size of the sheets with the wrapping method indicated by the instruction received by the receiving unit but falls within the size of the sheets with another of the plural wrapping methods.

8. The wrapping sheet output apparatus according to claim 6, wherein the output unit outputs one of the sheets as a wrapping sheet on which an image including folding lines is formed.

9. The wrapping sheet output apparatus according to claim 7, further comprising a notification unit that notifies the user of the other wrapping method that is different from the wrapping method indicated by the instruction from the user and is to be applied to the wrapping sheet to be output from the output unit.

10. A wrapping sheet output apparatus comprising:
a housing unit that houses sheets;
a recognizing unit that recognizes dimensions of an object to be wrapped; and
a judging unit that judges whether the sheets housed in the housing unit can be used as a wrapping sheet for wrapping the object to be wrapped based on dimensions of the sheets housed in the housing unit and the dimensions of the object to be wrapped recognized by the recognizing unit.

11. The wrapping sheet output apparatus according to claim 10, wherein:
the recognizing unit generates a development view based on the recognized dimensions; and
the judging unit judges that the sheets housed in the housing unit can be used as a wrapping sheet if the development view of the object to be wrapped falls within a size of the sheets housed in the housing unit.

12. The wrapping sheet output apparatus according to claim 10, wherein:
the housing unit houses plural sets of sheets having different sizes; and
the judging unit judges that the plural sets of sheets housed in the housing unit cannot be used as a wrapping sheet if the development view of the object to be wrapped does not fall within a maximum one of sizes of the plural sets of sheets.

13. The wrapping sheet output apparatus according to claim 10, further comprising a receiving unit that receives an instruction indicating one of plural wrapping methods from a user,
wherein the judging unit judges, for each of the plural wrapping methods, whether the sheets housed in the housing unit can be used as a wrapping sheet, and, if judging that the sheets housed in the housing unit cannot be used as a wrapping sheet with the wrapping method indicated by the instruction received by the receiving unit but can be used as a wrapping sheet with another of the plural wrapping methods, presents the other wrapping method to the user.

14. The wrapping sheet output apparatus according to claim 10, further comprising an image adding unit that adds an image to the wrapping sheet.

15. The wrapping sheet output apparatus according to claim 14, wherein the image adding unit adds, to the wrapping sheet, folding lines to be referred to in wrapping the object to be wrapped.
